(19) United States
(12) Patent Application Publication
(10) Pub. No.: US 2026/0048576 A1
(43) Pub. Date: Feb. 19, 2026

(54) THREADLIKE ADHESIVE STICKING APPARATUS AND METHOD OF STICKING THREADLIKE ADHESIVE

(71) Applicant: NITTO DENKO CORPORATION, Ibaraki-shi, Osaka (JP)

(72) Inventors: Shigeki ISHIGURO, Ibaraki-shi, Osaka (JP); Yosuke MAKIHATA, Ibaraki-shi, Osaka (JP); Atsushi TAKASHIMA, Ibaraki-shi, Osaka (JP); Kayo SHIMOKAWA, Ibaraki-shi, Osaka (JP)

(21) Appl. No.: 19/125,557

(22) PCT Filed: Oct. 27, 2023
(86) PCT No.: PCT/JP2023/039003

§ 371 Date: Apr. 29, 2025

(30) Foreign Application Priority Data
Oct. 31, 2022 (JP) 2022-175006

(51) Int. Cl. B32B 37/12

(52) U.S. Cl. CPC B32B 37/1292

(57) ABSTRACT

A threadlike adhesive sticking apparatus, for sticking a threadlike adhesive to an object by pressing a part of the threadlike adhesive protruding from a tip end portion of a nozzle to an outside against a surface of the object, includes a moving mechanism configured to move the nozzle. The moving mechanism moves the nozzle such that an angle θ1 (rad) formed by the surface and a moving direction of the nozzle to a sticking start point on the surface is π/36≤θ1≤4π/9.

### CROSS REFERENCE TO RELATED APPLICATION

This application is a National Stage of International Application No. PCT/JP2023/039003, filed on Oct. 27, 2023, which designates the United States and was published in Japan, and which is based upon and claims priority to Japanese Patent Application No. 2022-175006, filed on Oct. 31, 2022, in the Japan Patent Office. All of the aforementioned applications are hereby incorporated by reference in their entireties.

### TECHNICAL FIELD

The present invention relates to a threadlike adhesive sticking apparatus and a method of sticking a threadlike adhesive.

### BACKGROUND ART

In order to stick a threadlike adhesive to an adherend, it is necessary to continuously press the threadlike adhesive against the adherend. In particular, when adhesion to a start point, which is a first trigger, is insufficient, it is difficult to continuously stick the adhesive thereafter.

Patent Literature 1 discloses that a start point can be created by lowering a nozzle in an oblique direction at the start of sticking a threadlike adhesive without allowing the threadlike adhesive to enter the nozzle.

### CITATION LIST

### Patent Literature

Patent Literature 1: JP2021-161404A

### SUMMARY OF INVENTION

### Technical Problem

However, Patent Literature 1 merely discloses that the nozzle is lowered in the oblique direction, and does not disclose specific conditions for preventing the threadlike adhesive from entering the nozzle.

The present invention has been made in view of the above circumstances, and an object thereof is to provide a threadlike adhesive sticking apparatus and a method of sticking a threadlike adhesive capable of improving sticking accuracy at a sticking start point of a threadlike adhesive.

### Solution to Problem

A threadlike adhesive sticking apparatus according to the present invention is used for sticking a threadlike adhesive to an object by pressing, using a nozzle, a part of the threadlike adhesive protruding from a tip end portion of the nozzle to an outside against a surface of the object, and the apparatus includes: a moving mechanism configured to move the nozzle, in which
the moving mechanism moves the nozzle such that an angle θ1 (rad) formed by the surface and a moving direction of the nozzle to a sticking start point on the surface is π/36≤θ1≤4π/9.

In the threadlike adhesive sticking apparatus according to the present invention, for example, a length L (mm) of an extra length portion, which is a length of the threadlike adhesive protruding from the tip end portion to the outside at the sticking start point, and an outer diameter R (mm) of the threadlike adhesive are represented by the following relational expression.

$$5. \leq L / R$$

In the threadlike adhesive sticking apparatus according to the present invention, for example, a moving speed a (mm/sec) of the nozzle is in the following range.

$$1. \leq a \leq 40.0$$

In the threadlike adhesive sticking apparatus according to the present invention, for example, when a sticking direction of the threadlike adhesive from the sticking start point on the surface is defined as 0 (rad), a moving angle θ2 (rad) obtained by projecting the moving direction of the nozzle onto the surface is 11π/18≤θ2≤25π/18.

In the threadlike adhesive sticking apparatus according to the present invention, for example,
the moving mechanism moves the nozzle from a moving start point to a moving direction switching point, and then moves the nozzle such that the angle θ1 (rad) formed by the surface and a moving direction of the nozzle from the moving direction switching point to the sticking start point on the surface is π/36≤θ1≤4π/9, and
when a sticking direction from the sticking start point on the surface is defined as 0 (rad), a moving angle θ3 (rad) obtained by projecting the moving direction of the nozzle from the moving direction switching point for the nozzle to the sticking start point onto the surface is π.

In the threadlike adhesive sticking apparatus according to the present invention, for example, a distance between the moving direction switching point and the surface is smaller than a length of an extra length portion which is a length of the threadlike adhesive protruding from the tip end portion to the outside at the sticking start point.

A method of sticking a threadlike adhesive according to the present invention is used for sticking a threadlike adhesive to an object by pressing, using a nozzle, a part of the threadlike adhesive protruding from a tip end portion of the nozzle to an outside against a surface of the object, and the method includes: moving the nozzle such that an angle θ1 (rad) formed by the surface and a moving direction of the nozzle to a sticking start point on the surface is π/36≤θ1≤4π/9.

In the method of sticking a threadlike adhesive according to the present invention, for example, a length L (mm) of an extra length portion, which is a length of the threadlike adhesive protruding from the tip end portion to the outside at the sticking start point, and an outer diameter R (mm) of the threadlike adhesive are represented by the following relational expression.

$$5. \leq L / R$$

In the method of sticking a threadlike adhesive according to the present invention, for example, a moving speed a (mm/sec) of the nozzle is in the following range.

$$1. \leq a \leq 40.0$$

In the method of sticking a threadlike adhesive according to the present invention, for example, when a sticking direction of the threadlike adhesive from the sticking start point on the surface is defined as 0 (rad), a moving angle θ2 (rad) obtained by projecting the moving direction of the nozzle onto the surface is 11π/18≤θ2≤25π/18.

In the method of sticking a threadlike adhesive according to the present invention, for example,
the nozzle is moved from a moving start point to a moving direction switching point, and is then moved such that the angle θ1 (rad) formed by the surface and a moving direction of the nozzle from the moving direction switching point to the sticking start point on the surface is π/36≤θ1≤4π/9, and
when a sticking direction from the sticking start point on the surface is defined as 0 (rad), a moving angle θ3 (rad) obtained by projecting the moving direction of the nozzle from the moving direction switching point for the nozzle to the sticking start point onto the surface is π.

In the method of sticking a threadlike adhesive according to the present invention, for example, a distance between the moving direction switching point and the surface is smaller than a length of an extra length portion which is a length of the threadlike adhesive protruding from the tip end portion to the outside at the sticking start point.

### Advantageous Effects of Invention

According to the present invention, by setting an angle at which the nozzle is lowered to a predetermined value or less, sticking accuracy at the sticking start point of the threadlike adhesive can be improved.

### BRIEF DESCRIPTION OF DRAWINGS

FIG. 1 is a diagram conceptually showing a configuration of a threadlike adhesive sticking apparatus according to the present invention.

FIG. 2 is a schematic front view of a threadlike adhesive sticking apparatus according to a first embodiment.

FIG. 3 is a view showing a cut surface of a nozzle.

FIGS. 4A and B show conceptual diagrams showing a situation in which the nozzle approaches a surface of an object and presses a part of the threadlike adhesive against the surface of the object to stick the threadlike adhesive to the surface of the object, FIG. 4A shows a situation in which the nozzle approaches the surface of the object vertically, and FIG. 4B shows a situation in which the nozzle approaches the surface of the object from an oblique direction.

FIG. 5 is a table showing results of verifying a sticking state of the threadlike adhesive on the object by setting various values for a lowering angle and a lowering speed in lowering the nozzle.

FIG. 6A is a schematic diagram showing a relationship between a force applied to a sticking start point when the nozzle is in contact with the surface of the object and a reaction force applied to the threadlike adhesive, and FIG. 6B is a table and a graph showing a relationship between a nozzle lowering angle and a corresponding maximum lowering speed.

FIG. 7A and FIG. 7B show conceptual diagrams showing a moving direction of the nozzle by a vector, and FIG. 7A, FIG. 7B, and FIG. 7C are diagrams showing examples of different moving patterns.

FIG. 8 is a diagram showing a spiral figure drawn by sticking a threadlike adhesive to a nozzle.

FIG. 9 is a table showing conditions and results in the case where the threadlike adhesive is stuck according to any of the moving patterns in FIG. 7A to in FIG. 7C for five samples.

FIG. 10 is a conceptual diagram illustrating a moving angle θ2 on a XY plane.

FIG. 11A and FIG. 11B show diagrams schematically showing a behavior of the threadlike adhesive when the nozzle is in contact with the surface of the object, FIG. 11A showing the behavior in the case where an outer diameter of the threadlike adhesive is small, and FIG. 11B showing the behavior in the case where the outer diameter of the threadlike adhesive is large.

FIG. 12 is a schematic diagram showing an example in which the nozzle reaches the sticking start point from a moving start point through a two-stage movement.

FIG. 13 is a perspective view showing a threadlike adhesive sticking apparatus according to a second embodiment.

FIG. 14 is a front view showing a state where an opening/closing frame is open in the threadlike adhesive sticking apparatus according to the second embodiment.

FIG. 15 is a table showing experimental results for Examples 1 to 7.

FIG. 16 is a table showing experimental results for Comparative Examples 1 to 5.

FIG. 17 is a table showing experimental results for Examples 8 to 10 and Comparative Examples 6 and 7.

### DESCRIPTION OF EMBODIMENTS

Hereinafter, preferred embodiments of a threadlike adhesive sticking apparatus and a method of sticking a threadlike adhesive according to the present invention will be described in detail with reference to the drawings.

### First Embodiment

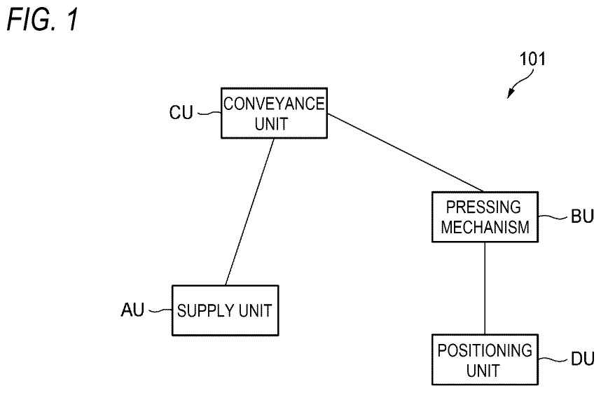

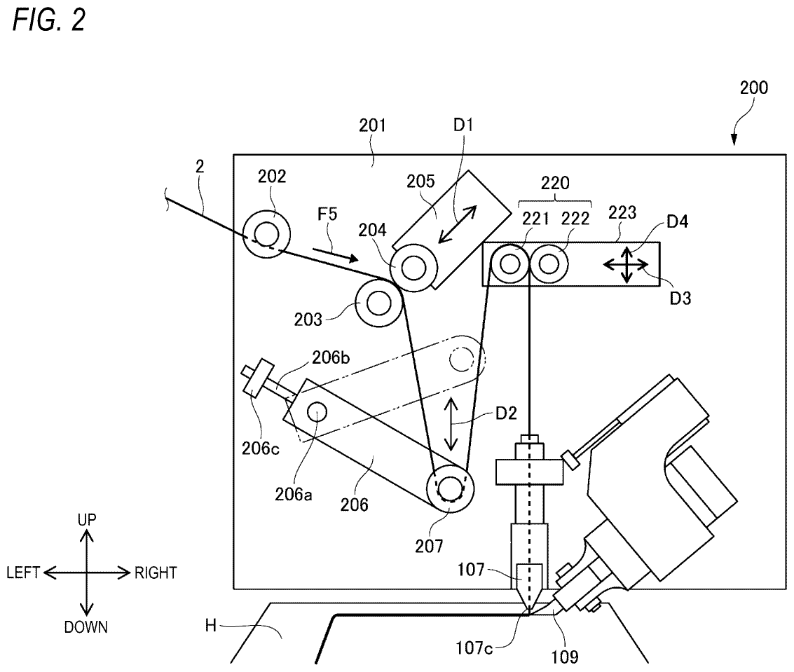

FIG. 1 is a diagram conceptually showing a configuration of a threadlike adhesive sticking apparatus according to the present invention. FIG. 2 is a schematic front view of a threadlike adhesive sticking apparatus according to a first embodiment. Note that, arrows shown in and after FIG. 2 indicate front-rear, left-right, and up-down directions of the threadlike adhesive sticking apparatus. The left-right direction is also referred to as an X-axis direction, the front-rear direction (width direction) is also referred to as a Y-axis direction, and the up-down direction (height direction) is also referred to as a Z-axis direction.

A threadlike adhesive sticking apparatus 200 is an apparatus that presses and sticks a threadlike adhesive 2 to an object (adherend), and mainly includes a supply unit AU, a pressing mechanism BU (nozzle), a conveyance unit CU, and a positioning unit DU, as shown in FIG. 1. The supply unit AU supplies the threadlike adhesive 2 wound in a roll shape. The pressing mechanism BU presses the supplied threadlike adhesive 2 against the adherend. The conveyance unit CU conveys the threadlike adhesive 2 from the supply unit AU to the pressing mechanism BU. The positioning unit DU positions the pressing mechanism BU relative to the object.

### (Positioning Unit DU)

The threadlike adhesive sticking apparatus 200 includes, as a part constituting an example of the positioning unit DU, a table (not shown) disposed on a base and a stage (not shown) slidable along the X-axis direction (left-right direction) on the table. The object is placed on an upper surface of the stage and mounted by suction or the like. When the stage is moved in the X-axis direction by a drive unit, the object is moved in the X-axis direction. In addition, the threadlike adhesive sticking apparatus 200 includes, for example, a pair of support columns (not shown) erected on left and right sides of the table, and a horizontal arm (not shown) installed between the pair of support columns along the Y-axis direction (front-rear direction) above the pair of support columns.

A horizontal moving unit slidable along the Y-axis direction is attached to the horizontal arm. The horizontal moving unit is moved in the Y-axis direction by a drive unit (not shown). A lifting body (not shown) is held by the horizontal moving unit so as to be slidable in the Z-axis direction (up-down direction). A nozzle 107 (see FIG. 2) is attached to the lifting body via an attachment plate or the like. That is, in the horizontal moving unit, the nozzle 107 is moved in the Z-axis direction by a drive unit (not shown). Details of the nozzle 107 will be described later.

The threadlike adhesive sticking apparatus 200 can relatively position the nozzle 107 with respect to the object in an XY plane by the stage and the horizontal moving unit, and can move the nozzle 107 in the Z-axis direction by lifting and lowering the lifting body of the horizontal moving unit. That is, the stage and the horizontal moving unit function as the positioning unit DU.

### (Supply Unit AU)

The threadlike adhesive sticking apparatus 200 includes a winding body and a winding body holding unit as an example of the supply unit AU. The winding body has a cylindrical shape such as a reel, a paper tube, and a bobbin. The threadlike adhesive 2 obtained by attaching an adhesive to a threadlike core material is wound around an outer peripheral surface of the winding body. The winding body can be formed of a metal, a resin, an easily releasable material, or the like. The winding body holding unit holds the winding body such that a movement of the winding body in the front-rear direction is restricted in the vicinity of both ends of the winding body around which the threadlike adhesive 2 is wound, and the winding body is rotatable as the threadlike adhesive 2 is conveyed (fed out). The threadlike adhesive 2 is an adhesive body obtained by covering a surface of a threadlike core material with an adhesive layer. Details of the threadlike adhesive 2 will be described later.

The threadlike adhesive sticking apparatus 200 can supply the threadlike adhesive 2 wound in a roll shape by using the winding body and the winding body holding unit. That is, the winding body and the winding body holding unit function as the supply unit AU.

### (Conveyance Unit CU)

In the threadlike adhesive sticking apparatus 200, main parts of the pressing mechanism BU and the conveyance unit CU are attached to a front surface of an attachment plate 201 having a substantially rectangular shape, and are positioned by the positioning unit DU.

The threadlike adhesive sticking apparatus 200 includes rollers 202, 203, and 204, a moving unit 205, an arm 206, rollers 207, 221, and 222, and a moving unit 223 as an example of the conveyance unit CU, and conveys the threadlike adhesive 2 fed out from the supply unit AU (winding body) to the nozzle 107.

The rollers 202, 203, 204, 207, 221, and 222 are rotatably attached to the attachment plate 201 directly or indirectly in a vertical plane (XZ plane). As an example, the rollers 202, 203, 204, 207, 221, and 222 are disposed such that respective rotation positions thereof are substantially the same distance from a front surface side of the attachment plate 201 (the front side of the paper in FIG. 2).

The roller 202 is attached to an upper left corner of the attachment plate 201, and guides the threadlike adhesive 2 to the rollers 203 and 204. On a left side of the roller 202, a roller (not shown) movable up and down according to a tension of the threadlike adhesive 2 to be conveyed and a roller (not shown) provided above a right side of this roller may be disposed. The tension of the threadlike adhesive 2 supplied to the roller 202 can be adjusted to be constant by these rollers.

The roller 203 is attached to the attachment plate 201 slightly below a right side of the roller 202. The roller 203 is a feed out roller that is driven and rotated by a motor (not shown).

The roller 204 is disposed on the upper right of the roller 203, and is attached to a lower left end portion of the moving unit 205 such as an air cylinder that is moved (slides) in a direction of an arrow D1 (upper right and lower left directions) with respect to the attachment plate 201. When the roller 204 is located at the lowest left, the roller 204 is rotated in conjunction with the rotation of the roller 203, sandwiches the threadlike adhesive 2 with the roller 203, and pulls out the threadlike adhesive 2 in a direction of an arrow F5.

The arm 206 is a rod-shaped body extending in the left-right direction below the rollers 202 and 203 and the moving unit 205. The roller 207 is attached to a right end portion of the arm 206. A vicinity of a left end portion of the arm 206 is rotatably supported to the attachment plate 201 by a rotation shaft 206a. A potentiometer for calculating a position of the roller 207 is attached to the rotation shaft 206a. The arm 206 is rotated in a direction of an arrow D2 (substantially in the up-down direction) by a drive unit such as a motor provided on a rear side of the attachment plate 201, for example. That is, the roller 207 is movable in the up-down direction by the rotation of the arm 206.

A shaft 206b, which extends along an extending direction of the arm 206 and is provided with a spiral ridge on an outer peripheral surface thereof, protrudes from the left end portion of the arm 206. One or more weights 206c are attached to the shaft 206b. The weight 206c has a substantially disc shape, and a through hole provided at a center of the weight 206c is formed with a groove to be screwed with the ridge of the shaft 206b. The position of the weight 206c on the shaft 206b can be shifted to change a distance between the weight 206c and the rotation shaft 206a, that is, a distance between the weight 206c and the left end portion of the arm 206. Therefore, the ease of movement of the arm 206 can be controlled by shifting the position of the weight 206c on the shaft 206b.

The rollers 221 and 222 are attached to the upper right of the roller 207 and a right side of the roller 204 in the attachment plate 201. The rollers 221 and 222 guide the threadlike adhesive 2 pulled out by the rollers 203 and 204 and passing the roller 207 to the pressing mechanism BU (nozzle 107) provided directly below the rollers 221 and 222.

When the roller 207 is moved downward, that is, the roller 207 is displaced so as to lengthen a path from the rollers 203 and 204 to the roller 221, a conveying speed of the threadlike adhesive 2 decreases. In this way, the threadlike adhesive 2 is fed out by the rollers 203 and 204, and a rapid speed change of the fed-out threadlike adhesive 2 can be alleviated by the displacement of the roller 207. That is, the rollers 203, 204, 207, 221, and 222 and the arm 206 function as a feed out assist mechanism.

Further, the rollers 221 and 222 are attached to the moving unit 223 that moves in directions of arrows D3 and D4 (the left-right direction and the up-down direction) with respect to the attachment plate 201. The rollers 221 and 222 provided upstream of the nozzle 107 function as a chuck unit 220 that nips (chucks) the threadlike adhesive 2 after the sticking of the threadlike adhesive 2 is completed, the nozzle 107 is raised and the threadlike adhesive 2 is cut at a position close to an adherend H.

### (Pressing Mechanism BU)

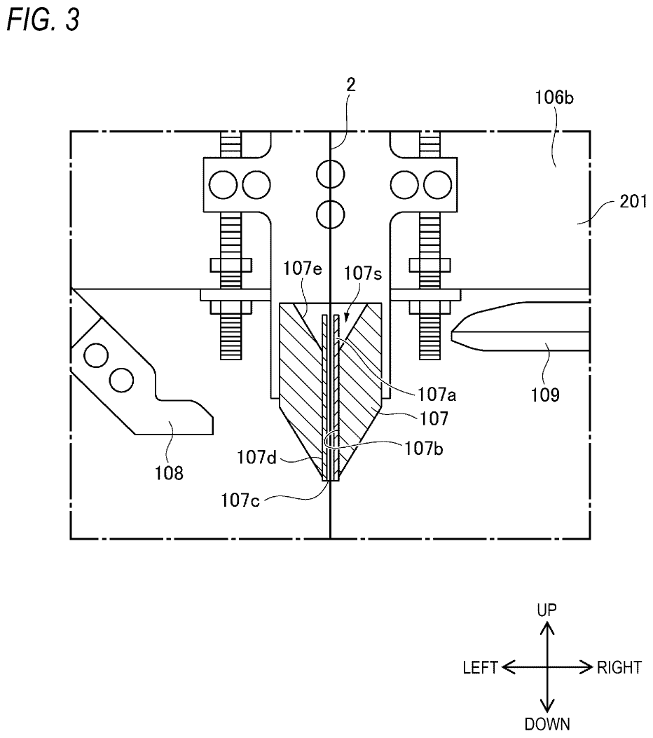

An example of the pressing mechanism BU provided on the threadlike adhesive sticking apparatus 200 will be described with reference to FIG. 3. FIG. 3 is a view showing a periphery of the nozzle 107 of the threadlike adhesive sticking apparatus 200, and is a view including a cross section of the nozzle 107 in the XZ plane along the threadlike adhesive 2.

The threadlike adhesive sticking apparatus 200 includes the nozzle 107 as a part constituting an example of the pressing mechanism BU. The attachment plate 201 includes a nozzle attachment portion 106b and a substantially rectangular connection portion elongated in the Z direction. The nozzle attachment portion 106b is a substantially rectangular portion extending in the Y direction below the connection portion. The nozzle 107, an air chuck 108, and an air scissor 109 are attached to a front side of the nozzle attachment portion 106b.

When the sticking of the threadlike adhesive 2 is completed, the air chuck 108 and the air scissor 109 are separately moved by a drive unit from a normal position shown in FIG. 3. The air chuck 108 is moved obliquely from the normal position to the lower right, and chucks the threadlike adhesive 2 directly below the nozzle 107. The air scissor 109 is moved downward from the normal position and then moved leftward to cut the chucked threadlike adhesive 2 directly below the air chuck 108. The air chuck 108 and the air scissor 109 are attached to the lifting body of the horizontal moving unit via the attachment plate 201, similar to the nozzle 107, and can therefore move together with the nozzle 107 while maintaining a positional relationship with respect to the nozzle 107. Note that, the shape, the driving method, and the like of the air chuck 108 and the air scissor 109 are not limited as long as they can hold and cut the threadlike adhesive 2 at predetermined positions. In addition, instead of the air scissor 109, the threadlike adhesive 2 may be baked and cut by heat cutting using a heat cutter or the like.

The nozzle 107 is a member formed of aluminum or the like and having a shape obtained by connecting a bottom surface of a cone to a lower surface of a cube. The nozzle 107 has an inner wall surface 107b that defines a cylindrical internal space 107s extending in the up-down direction, and a tip end 107d having a tip end opening 107c at a lower end portion of the inner wall surface 107b, the tip end opening 107c allowing the cylindrical internal space 107s to communicate with the outside. The nozzle 107 is a member formed of a metal or the like, and a surface of the nozzle 107 including the inner wall surface 107b and the tip end 107d is subjected to a slidability improving process. The nozzle 107 has an insertion-side opening 107e at an upper end portion of the inner wall surface 107b, the insertion-side opening 107e allowing the cylindrical internal space 107s to communicate with the outside. The inner wall surface 107b is formed such that the cylindrical internal space 107s has a funnel shape in which a cylinder having the same diameter as the tip end opening 107c extends upward from the tip end opening 107c and gradually increases in diameter. The insertion-side opening 107e has a funnel shape whose diameter is larger than that of the tip end opening 107c. Note that, the inner wall surface 107b needs only to define a cylindrical internal space, and for example, an upper portion of the inner wall surface 107b may be formed as a cylinder or the like having the same diameter instead of a funnel shape.

In the cylindrical internal space 107s of the nozzle 107, a tube 107a formed of a hardly adhesive resin such as polytetrafluoroethylene (PTFE) and having a hollow cylindrical shape from an upper end to below a lower end (tip end 107d) of the nozzle 107 may be provided. Alternatively, a surface treatment for improving slidability may be performed. A diameter of the threadlike adhesive 2 is preferably, for example, 0.45 mm with respect to a diameter of a lower side opening of, for example, about 1 mm in the tube 107a. That is, a cross-sectional area of the lower side opening of the tube 107a is preferably about 4.9 times a cross-sectional area of the threadlike adhesive 2. The tube 107a protrudes slightly (for example, about 0.5 mm to 1 mm) from a lower end of the inner wall surface 107b. By inserting the threadlike adhesive 2 into the tube 107a, the slidability (feedability) of the threadlike adhesive 2 is improved. Since the insertion-side opening 107e is enlarged in diameter, it is easy to insert the threadlike adhesive 2 into the nozzle 107. Note that, when the material of the nozzle 107 itself is a hardly adhesive resin such as PTFE, it is possible to prevent the threadlike adhesive 2 from adhering to the nozzle 107. Accordingly, the threadlike adhesive 2 can be smoothly fed out from the nozzle 107 without being caught, and thus the tube 107a is unnecessary. Further, the shape of the nozzle 107 is not limited as long as the nozzle 107 has a cylindrical internal space and a tip end having a tip end opening through which the internal space communicates with the outside. In addition, in the nozzle 107, the shape of the tip end opening 107c or the shape of the lower side opening of the tube 107a is preferably a circular shape or a polygonal shape having five or more corners.

The nozzle 107 presses the threadlike adhesive 2, which has been allowed to pass through the tube 107a (cylindrical internal space 107s) and has been led out to the outside from the lower side opening (tip end opening 107c) of the tube 107a, against the object. More specifically, an entire circumference or a plurality of any positions of a lower end portion of the tube 107a, which is a peripheral portion surrounding the tip end opening 107c of the nozzle 107, function as the pressing unit that presses the threadlike adhesive 2 against the object. Therefore, it is possible to stick the threadlike adhesive 2 while moving the nozzle 107 in a plurality of optional directions without using a roller or the like as the pressing unit. Therefore, in the case where the adhesive is pressed by the roller, it is possible to prevent a problem that the sticking accuracy is poor due to the movement of the adhesive within a roller width, and the adhesive is detached from the roller depending on a sticking path, and thus it is possible to accurately stick the threadlike adhesive 2.

### (Movement of Nozzle)

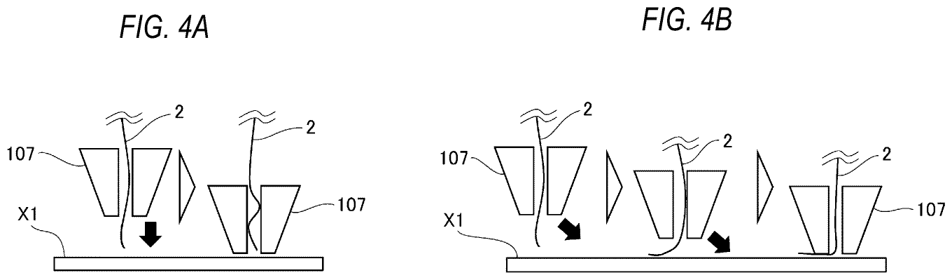

FIG. 4A and FIG. 4B are a conceptual diagram showing a situation in which the nozzle 107 approaches a surface of an object X1 and presses a part of the threadlike adhesive 2 against the surface of the object X1 to stick the threadlike adhesive 2 to the surface of the object X1. The nozzle 107 starts to stick the threadlike adhesive 2 by pressing a part of the threadlike adhesive 2, in particular, a part of a tip end of the threadlike adhesive 2, protruding a tip end portion of the nozzle 107 to the outside against the surface of the object X1. The nozzle 107 is movable relative to the object X1 by, for example, a moving mechanism including the stage and the horizontal moving unit of the positioning unit DU described above.

FIG. 4A shows a situation in which the nozzle 107 approaches the surface of the object X1 vertically. In the case where an extra length is short at the start of sticking the threadlike adhesive 2, when the nozzle 107 is vertically lowered, the threadlike adhesive 2 may enter the nozzle 107 and the start point may not stick to the object X1.

On the other hand, FIG. 4B shows a situation in which the nozzle 107 approaches the surface of the object X1 from an oblique direction. When the nozzle 107 is lowered in an oblique direction, the threadlike adhesive 2 is sandwiched between the nozzle 107 and the object X1 without the threadlike adhesive 2 entering the nozzle 107, so that the start point can be created on the object X1.

The inventor has more deeply verified, based on the concept shown in FIG. 4B, that the threadlike adhesive 2 entering the nozzle 107 at the start of sticking the threadlike adhesive 2 and a deviation from the sticking start point (start point, drawing start point) are prevented, and the sticking accuracy at the sticking start point of the threadlike adhesive 2 is improved. Hereinafter, the verification work will be described in order.

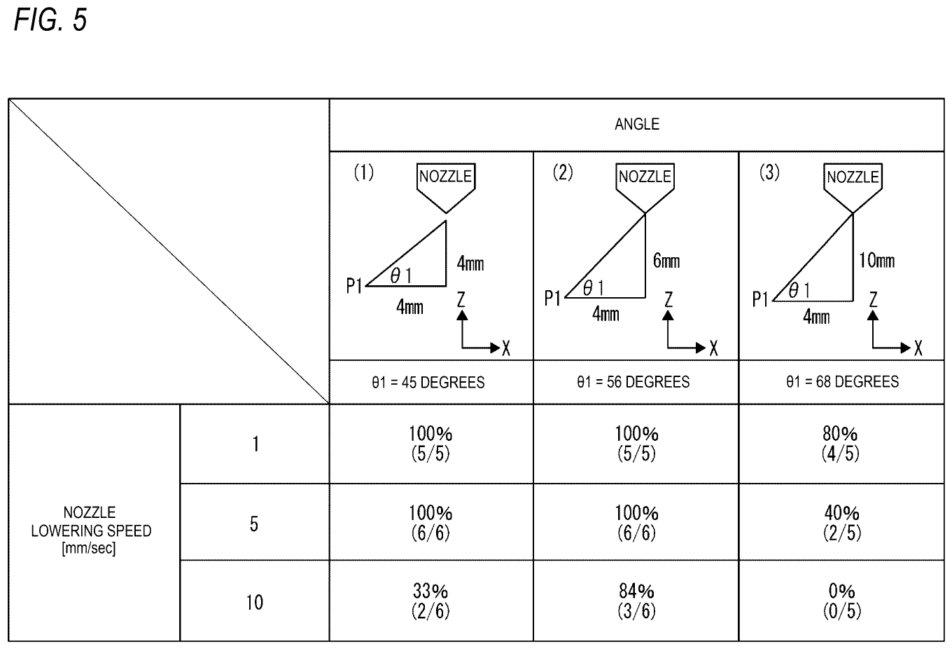

First, the inventor has set various values for a lowering angle (nozzle lowering angle) and a lowering speed (nozzle lowering speed) in lowering the nozzle 107, and has examined a sticking state (drawing state) of the threadlike adhesive 2 on the object X1. A table in FIG. 5 shows the verification results, and the uppermost diagrams in the table show a situation in which the nozzle 107 approaches a sticking start point P1 on the surface of the object X1 from a position away by a predetermined distance in the X-axis direction (left-right direction) and the Z-axis direction (height direction). An outer diameter of the threadlike adhesive 2 is 0.4 mm, and the extra length of the threadlike adhesive 2 protruding from the tip end of the nozzle 107 to the outside is 4 mm. In this state, a pushing amount of the threadlike adhesive 2 when the nozzle is in contact with the surface of the object X1 is adjusted to 3 mm.

(1) In this example, the nozzle 107 approaches the sticking start point P1 from a position 4 mm away from the sticking start point P1 in the X-axis direction and 4 mm away from the sticking start point P1 in the Z-axis direction. At this time, a nozzle lowering angle θ1 is 45 degrees. (2) In this example, the nozzle 107 approaches the sticking start point P1 from a position 4 mm away from the sticking start point P1 in the X-axis direction and 6 mm away from the sticking start point P1 in the Z-axis direction. At this time, the nozzle lowering angle θ1 is 56 degrees. (3) In this example, the nozzle 107 approaches the sticking start point P1 from a position 10 mm away from the sticking start point P1 in the X-axis direction and 4 mm away from the sticking start point P1 in the Z-axis direction. At this time, the nozzle lowering angle θ1 is 68 degrees.

Further, the inventor has examined the sticking state by changing a nozzle lowering speed in the examples (1) to (3) in which the nozzle lowering angles θ1 are different. In the examples (1) to (3), the nozzle lowering speed is examined in three different patterns of 1 mm/sec, 5 mm/sec, and 10 mm/sec. The nozzle lowering speed here is not a speed in the Z-axis direction, but is a moving speed of the nozzle in an oblique direction along a moving direction of the nozzle 107. Note that, regarding the sticking state, after the nozzle 107 is brought into contact with the surface of the object X1, the nozzle 107 is moved linearly in the X-axis direction at a speed of 20 mm/sec (sticking speed) by the moving mechanism, and the state after the threadlike adhesive 2 is stuck is observed.

As seen from the results shown in the table, for example, in the case where the nozzle lowering speed is 1 mm/sec in the example of (1), a good sticking state can be obtained in all of five samples (5/5). In addition, for example, in the case where the nozzle lowering speed is 5 mm/sec in the example of (2), a good sticking state can be obtained in five samples among six samples (5/6). In addition, for example, in the case where the nozzle lowering speed is 10 mm/sec in the example of (3), no good sticking state can be obtained in all of the five samples (0/5).

Accordingly, the inventor has found that the smaller the nozzle lowering speed, the better the sticking state can be obtained, and the slower the nozzle lowering speed, the better the sticking state can be obtained.

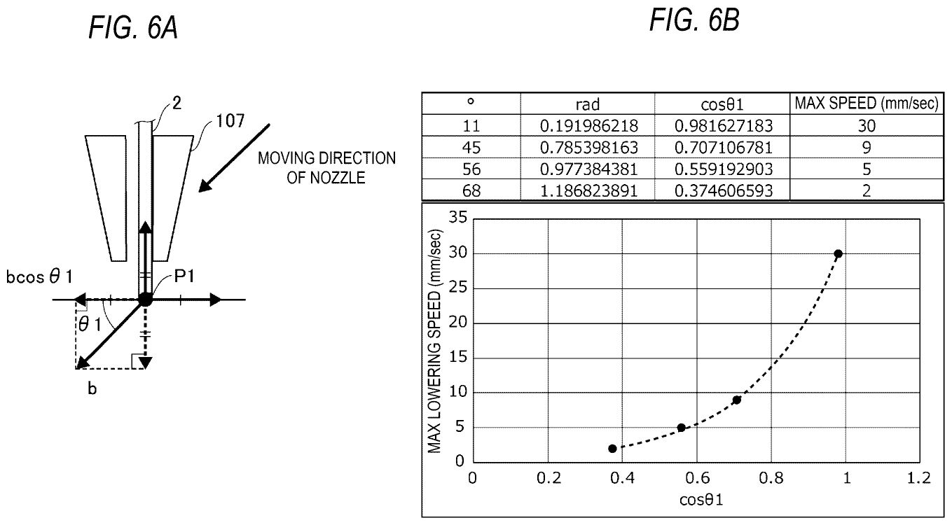

FIG. 6A is a schematic diagram showing a relationship between a force applied to the sticking start point P1 when the nozzle 107 is in contact with the surface of the object X1 and a reaction force applied to the threadlike adhesive 2. It can be seen that in the case where a force b, which is a vector quantity, is applied from the nozzle 107 to the sticking start point P1, a force that tilts the threadlike adhesive 2 is a reaction force of b cos θ1. When the nozzle lowering speed increases, the force b also increases. The same applies to the reaction force in the vertical direction, and the influence on the speed increases as the nozzle lowering angle θ1 increases.

FIG. 6B is a table and a graph showing a relationship between the nozzle lowering angle and a corresponding maximum (MAX) lowering speed. The inventor has examined the maximum lowering speed when the nozzle lowering angle θ1 is set to θ1=11 degrees, 45 degrees, 56 degrees, and 68 degrees, and has acquired the shown table and graph. The maximum lowering speed means the maximum nozzle lowering speed at which a good sticking state of the threadlike adhesive 2 can be obtained at a predetermined nozzle lowering angle θ1. It can be seen that the smaller the nozzle lowering angle θ1 (the larger the cos θ1), the smaller the influence of the nozzle lowering speed, and a good sticking state can be obtained even when the nozzle lowering speed is large. On the other hand, it can be seen that the larger the nozzle lowering angle θ1 (the smaller the cos θ1), the larger the influence of the nozzle lowering speed, and a good sticking state can be obtained by reducing the nozzle lowering speed.

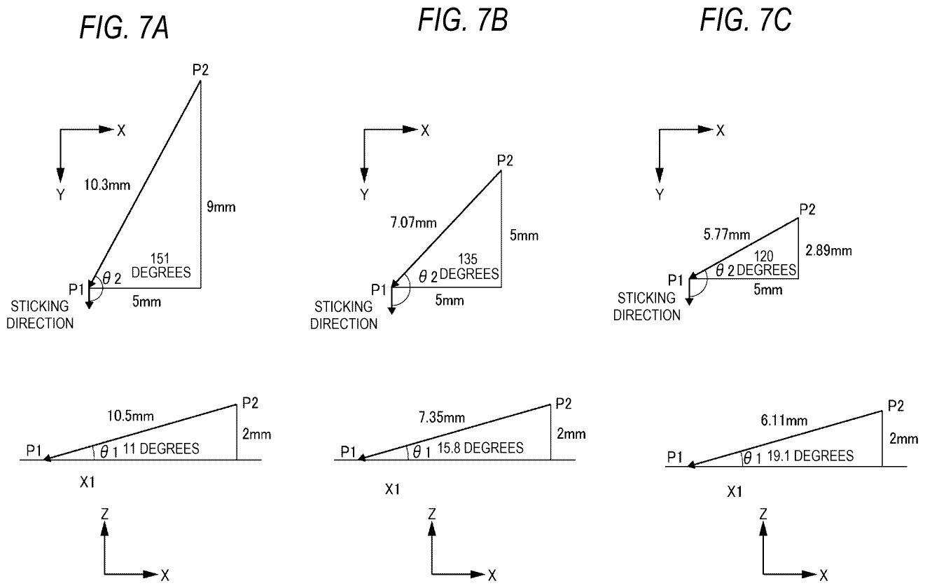

Further, the inventor has verified not only the nozzle lowering angle θ1 as shown in FIG. 5, FIG. 6A, and FIG. 6B, but also a movement of the nozzle 107 after the contact. FIG. 7A, FIG. 7B, and FIG. 7C show conceptual diagrams showing a moving direction of the nozzle 107 by a vector, and FIG. 7A, FIG. 7B, and FIG. 7C are diagrams showing examples of different moving patterns.

For example, the lower diagram in FIG. 7A shows a situation in which the nozzle 107 approaches the sticking start point P1 from a moving start point P2, which is a position 2 mm away from the sticking start point P1 in the Z-axis direction. On the other hand, the upper diagram corresponds to a diagram when the lower diagram is viewed from above, and shows a situation in which the nozzle 107 approaches the sticking start point P1 from the moving start point P2, which is a position 5 mm away from the sticking start point P1 in the X-axis direction and 9 mm away from the sticking start point P1 in the Y-axis direction, on the XY plane. The nozzle 107 moves in a predetermined sticking direction on the surface of the object X1 parallel to the XY plane, and sticks the threadlike adhesive 2 to the surface of the object X1. At this time, an angle formed by a vector obtained by projecting the moving direction of the nozzle 107 to the sticking start point P1 onto the surface of the object X1 and the sticking direction is defined as a moving angle θ2. In the example in FIG. 7A, the nozzle lowering angle θ1 is 11 degrees, and the moving angle θ2 is 151 degrees.

Similarly, the lower diagram in FIG. 7B shows a situation in which the nozzle 107 approaches the sticking start point P1 from the moving start point P2, which is a position 2 mm away from the sticking start point P1 in the Z-axis direction. On the other hand, the upper diagram corresponds to a diagram when the lower diagram is viewed from above, and shows a situation in which the nozzle 107 approaches the sticking start point P1 from the moving start point P2, which is a position 5 mm away from the sticking start point P1 in the X-axis direction and 5 mm away from the sticking start point P1 in the Y-axis direction, on the XY plane. In the example in FIG. 7B, the nozzle lowering angle θ1 is 15.8 degrees, and the moving angle θ2 is 135 degrees.

Similarly, the lower diagram in FIG. 7C shows a situation in which the nozzle 107 approaches the sticking start point P1 from the moving start point P2, which is a position 2 mm away from the sticking start point P1 in the Z-axis direction. On the other hand, the upper diagram corresponds to a diagram when the lower diagram is viewed from above, and shows a situation in which the nozzle 107 approaches the sticking start point P1 from the moving start point P2, which is a position 5 mm away from the sticking start point P1 in the X-axis direction and 2.89 mm away from the sticking start point P1 in the Y-axis direction, on the XY plane. In the example in FIG. 7C, the nozzle lowering angle θ1 is 19.1 degrees, and the moving angle θ2 is 120 degrees.

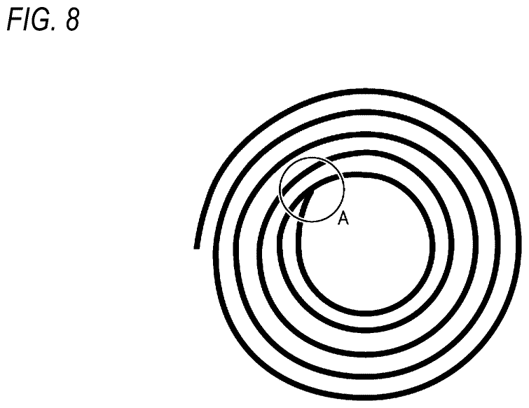

That is, the moving angle θ2 is a parameter indicating the movement of the nozzle 107 after the contact, and the inventor has presumed that the sticking state of the threadlike adhesive 2 also varies depending on the moving angle θ2. Based on this presumption, the inventor has controlled the movement of the nozzle 107 by a program so as to perform drawing in which the threadlike adhesive 2 is stuck in a spiral shape as shown in FIG. 8, and has observed the state after the nozzle 107 is moved in a spiral shape at a speed of 20 mm/sec by the moving mechanism after the nozzle 107 is brought into contact with the surface of the object X1. The outer diameter of the threadlike adhesive 2 is 0.4 mm, and the extra length of the threadlike adhesive 2 protruding from the tip end of the nozzle 107 to the outside is 4 mm. In this state, the pushing amount of the threadlike adhesive 2 during contact of the nozzle is adjusted to 3 mm.

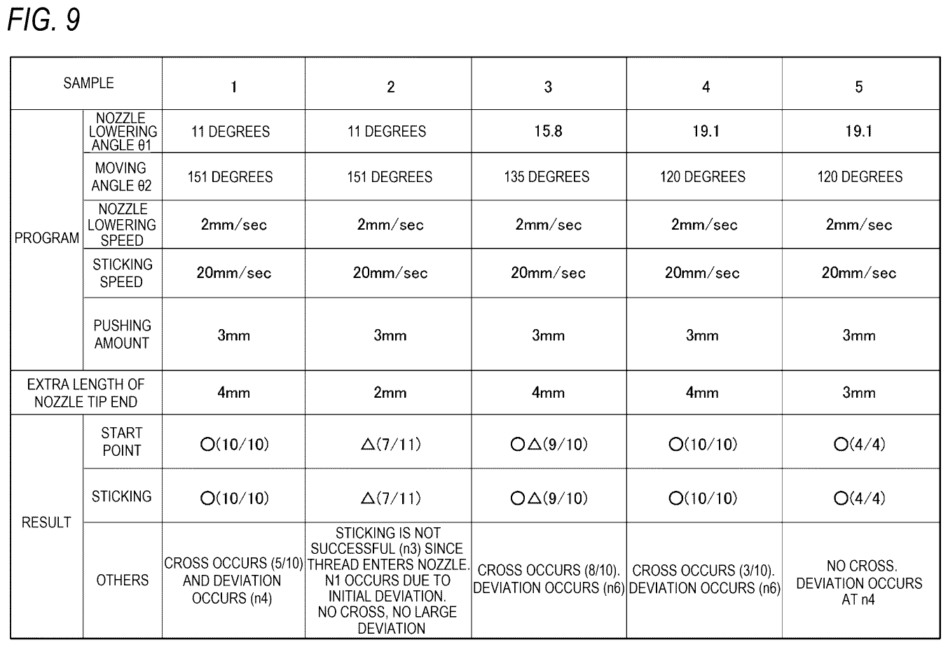

FIG. 9 shows conditions and results for five samples prepared by the above control. The conditions for samples 1 and 2 correspond to the moving pattern in FIG. 7A, the condition for sample 3 corresponds to the moving pattern in FIG. 7B, and the conditions for samples 4 and 5 correspond to the moving pattern in FIG. 7C.

In the program for moving the nozzle 107, that is, the program for driving the moving mechanism for the nozzle, the nozzle lowering angle θ1, the moving angle θ2, the nozzle lowering speed, a sticking speed, and the pushing amount are set as numerical values in the table for each sample. The extra length of the threadlike adhesive 2 protruding from the tip end portion of the nozzle 107 to the outside is set in advance to the numerical values in the table for each sample.

As shown in the lower part in the table, the start point, the sticking state, and others are evaluated as results. For “others”, as in a region A shown in FIG. 8, the presence or absence of a portion where the threadlike adhesive overlaps (interferes with) the next drawing, that is, a so-called cross is evaluated.

As a result of the evaluation, it has been found that when the extra length of the threadlike adhesive is too short, the threadlike adhesive tends to enter the inside of the nozzle 107, and when the extra length is too long, the threadlike adhesive tends to cross the inside of the nozzle 107, so that it is optimal to set the extra length to 3 mm. In addition, it has been found that when the moving angle θ2 is large, cross is likely to occur, and when the moving angle θ2 is too small, a deviation is likely to occur at the sticking start point. Note that, it is estimated that the nozzle lowering angle θ1 does not have a large influence within the evaluation range.

The inventor has performed the verification experiments in FIGS. 5 to 9 on more samples as shown in Examples and Comparative Examples to be described later, and has performed more detailed observation. Accordingly, the inventor has found the following conclusion.

The moving mechanism for moving the nozzle 107 desirably moves the nozzle 107 such that an angle θ1 (rad) formed by the surface of the object X1 and the moving direction of the nozzle 107 to the sticking start point on the surface, that is, the nozzle lowering angle θ1 is

$$π / 36 \leq θ 1 \leq 4 π / 9.$$

By setting the angle θ1 at which the nozzle 107 is lowered to a predetermined value or less, particularly 4π/9 (80°) or less, even in the case where the length of the threadlike adhesive protruding from the tip end portion of the nozzle 107 to the outside at the sticking start point, that is, the length of the extra length portion is short, the extra length portion of the threadlike adhesive can be sandwiched between the surface of the object and the nozzle tip end and brought into close contact with the sticking start point. Therefore, it is possible to obtain a good start point sticking property and to improve the sticking accuracy at the sticking start point of the threadlike adhesive.

On the other hand, even when the extra length is short, if the angle θ1 is small, the threadlike adhesive can be stuck to the sticking start point, but the moving distance of the nozzle on the plane increases, and it is difficult to stick the threadlike adhesive to a narrow place. In addition, the time required to move the nozzle to the sticking start point is longer, and the work time is longer. Therefore, when the angle θ1 is set to π/36 (5°) or more, sticking workability is improved.

Note that, in the case where the surface of the object X1 is a curved surface, the angle θ1 is defined by an angle formed by a tangent plane at the sticking start point and the moving direction of the nozzle 107.

In addition, a moving speed a (mm/sec) of the nozzle 107, that is, the nozzle lowering speed is desirably in the following range.

$$1. \leq a \leq 40.0$$

By setting the moving speed a to 40.0 mm/sec or less, it is possible to obtain a good start point sticking property while adjusting the angle θ1, and to shorten the work time. On the other hand, by setting the moving speed a to 1.0 mm/sec or more, it is possible to obtain a good start point sticking property and to prevent the work time from being excessively long.

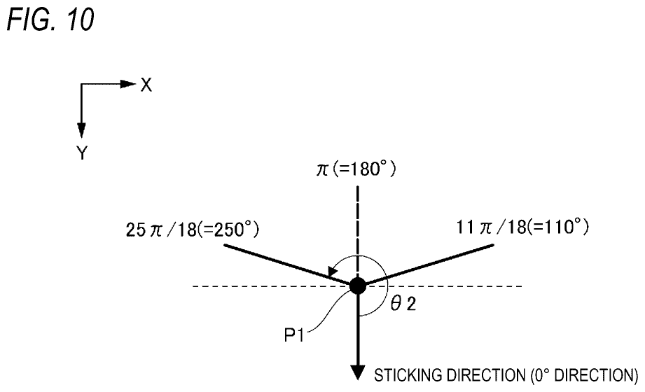

FIG. 10 is a conceptual diagram illustrating the moving angle θ2 on the XY plane also shown in FIG. 7A, FIG. 7B, and FIG. 7C. After the contact of the nozzle 107, the sticking direction in which the threadlike adhesive 2 is stuck is a 0 degree direction as a reference. An angle provided between the sticking direction and the vector of the moving direction of the nozzle in a counterclockwise direction is the moving angle θ2.

Under such definitions, when the sticking direction of the threadlike adhesive 2 from the sticking start point on the surface of the object X1 is defined as 0 (rad), the moving angle θ2 (rad) obtained by projecting the moving direction of the nozzle 107 onto the surface is desirably 11π/18≤θ2≤25π/18. FIG. 10 shows this range.

It is ideal to lower the nozzle 107 from an opposite direction (θ2=π) opposite to the sticking direction after the contact of the nozzle 107. However, in consideration of factors such as subsequent drawing and spatial restrictions, the moving direction should be inclined, that is, the nozzle 107 should be brought into contact with the start point from an oblique direction in the XY plane, and the degree of freedom of the movement of the nozzle 107 should be ensured. Therefore, by setting the moving angle θ2 to be 11π/18 (110°) or more and 25π/18 (250°) or less, it is possible to obtain a good start point sticking property and to ensure the degree of freedom of the movement of the nozzle 107.

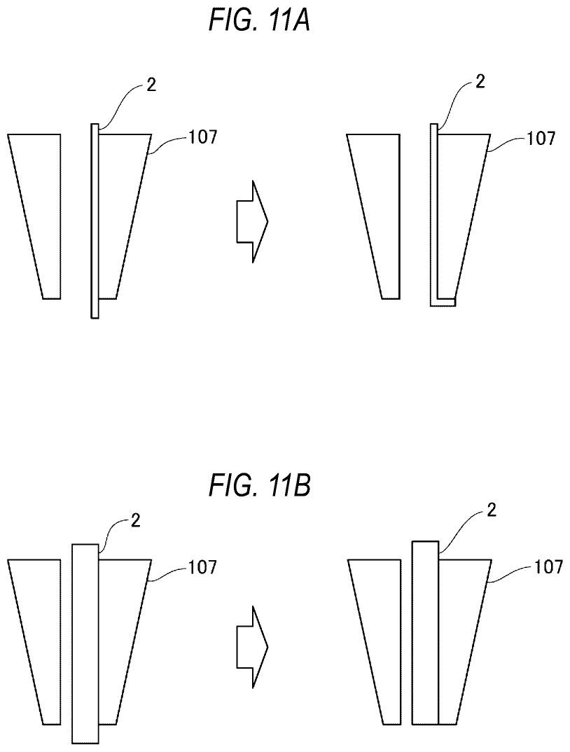

Further, the inventor has studied a relationship between the outer diameter and the extra length of the threadlike adhesive 2. FIG. 11A and FIG. 11B schematically show a behavior of the threadlike adhesive 2 during the contact of the nozzle 107. As shown in FIG. 11A, since the threadlike adhesive 2 is easily bent when the outer diameter R of the threadlike adhesive 2 is small, it is considered that the threadlike adhesive 2 is easily prevented from entering the nozzle 107 even when a length L of the extra length portion is short. On the other hand, shown in FIG. 11B, since the threadlike adhesive 2 is difficult to bend even with the same length L of the extra length portion when the outer diameter R of the threadlike adhesive 2 is large, it is considered difficult to prevent the threadlike adhesive 2 from entering the nozzle 107.

At present, in the case where the outer diameter R of the threadlike adhesive 2 is 0.4 mm, the length L of the extra length portion needs to be 2.0 mm or more. Therefore, the length L (mm) of the extra length portion, which is the length of the threadlike adhesive 2 protruding from the tip end portion of the nozzle 107 to the outside at the sticking start point, and the outer diameter R (mm) of the threadlike adhesive 2 are desirably represented by the following relational expression.

$$5. \leq L / R$$

When the threadlike adhesive 2 does not protrude from the tip end portion of the nozzle 107, the sticking cannot be performed, but when the extra length is too long, there is a risk that the extra length portion overlaps the next drawing. This also leads to a material loss. Further, adhesion at the start point also varies depending on the outer diameter of the threadlike adhesive 2. When the outer diameter of the threadlike adhesive 2 is small, the threadlike adhesive 2 can be laid sideways even with a short extra length, but when the outer diameter is large, the threadlike adhesive 2 is pushed back into the nozzle 107 with a short extra length. When the relationship between the length L of the extra length portion and the outer diameter R of the threadlike adhesive 2 is 5.0≤L/R, a good start point sticking property can be obtained.

Note that, a maximum value of the length L of the extra length portion should be set to a length that does not influence the sticking of the threadlike adhesive 2, and is desirably set to 10.0 mm or less regardless of the outer diameter R.

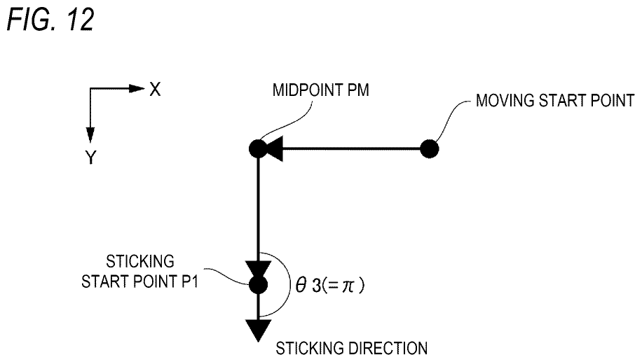

FIG. 12 shows another example of the movement of the nozzle 107. In this example, the moving mechanism for the nozzle 107 temporarily moves the nozzle 107 from the moving start point to a midpoint PM above the object X1. Thereafter, the moving mechanism switches a traveling angle of the nozzle 107 in the XY plane, and moves the nozzle 107 such that the angle θ1 (rad) formed by the surface of the object X1 and a moving direction of the nozzle 107 from the midpoint PM to the sticking start point on the surface is π/36≤θ1≤4π/9. That is, the midpoint PM is a point at which the moving angle of the nozzle 107 projected in the XY plane direction is switched, and the movement from the midpoint PM to the sticking start point is the same as in the above example. The midpoint PM corresponds to the moving start point P2 in the above example. Therefore, the nozzle 107 reaches the sticking start point from the moving start point through a two-stage movement. In other words, the nozzle 107 performs a first stage movement from the moving start point to the midpoint PM and a second stage movement from the midpoint PM to the sticking start point. The midpoint PM is a switching point between the first stage and the second stage, and is an example of a moving direction switching point.

In this example, when the sticking direction from the sticking start point P1 on the surface of the object X1 is defined as 0 (rad), the moving mechanism controls the position of the nozzle 107 such that a moving angle θ3 (rad) obtained by projecting the moving direction of the nozzle 107 from the midpoint PM for the nozzle 107 to the sticking start point on the surface is π(180°).

In this example, the moving mechanism moves the nozzle 107 from the moving start point, and once the nozzle 107 reaches the midpoint PM at a position of 180° with respect to the sticking direction, temporarily stops the nozzle 107, and then moves the nozzle 107 in the 0° direction (sticking direction) in the Y direction. Thereafter, the nozzle 107 finally comes into contact with the object X1 at the sticking start point P1. Accordingly, since the moving direction of the nozzle 107 from the midpoint PM is always a straight line with respect to the sticking direction on the XY plane, it is possible to prevent a deviation at the sticking start point P1 and to start the drawing with high accuracy.

Note that, at the midpoint PM, a distance from the surface of the object X1 (here, a distance in the Z-axis direction) is desirably smaller than the length L of the extra length portion which is the length of the threadlike adhesive 2 protruding from the tip end portion of the nozzle 107 to the outside at the sticking start point.

### Second Embodiment

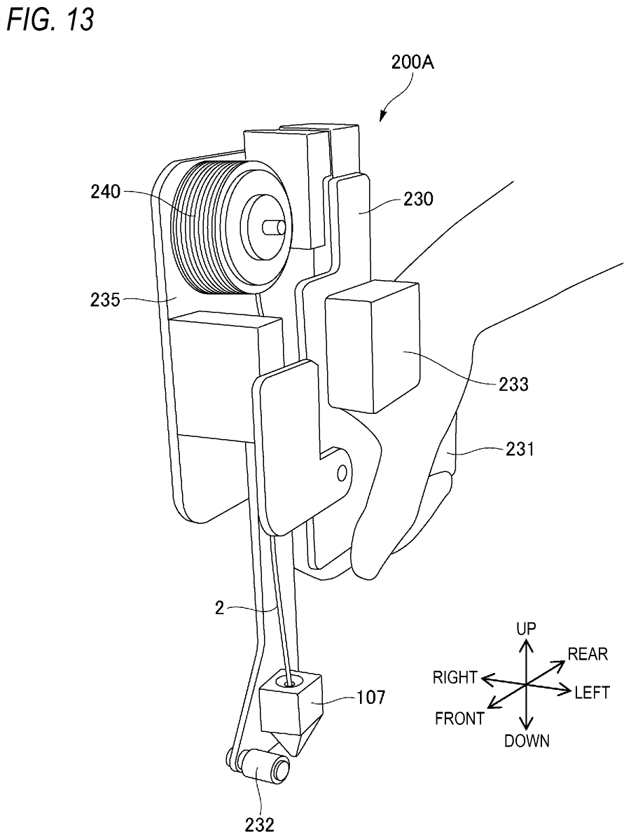

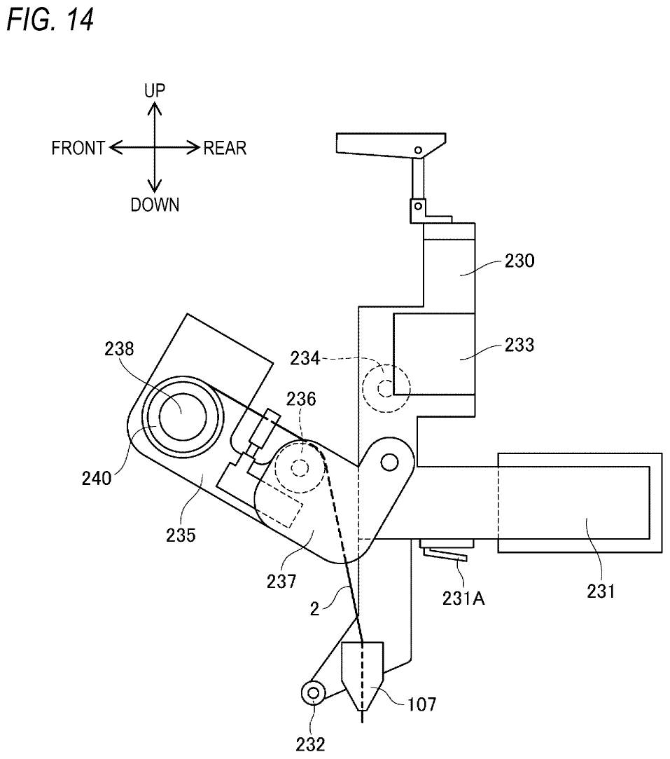

FIG. 13 is a perspective view showing a threadlike adhesive sticking apparatus 200A according to a second embodiment. FIG. 14 is a front view showing a state where an opening/closing frame 235 is open in the threadlike adhesive sticking apparatus 200A. The threadlike adhesive sticking apparatus 200A mainly includes a main body frame 230, a gripping portion 231, and the opening/closing frame 235 in which a winding body 240 capable of winding the threadlike adhesive 2 is held.

In the main body frame 230, a lower portion of an elongated plate member extending in the up-down direction is bent in an oblique direction to be tapered. The nozzle 107 is fixed to a bent portion of the main body frame 230, and a pressing roller 232 is provided at the tapered lower end. As shown in FIG. 14, the nozzle 107 is attached along an axial direction of the main body frame 230. In addition, the pressing roller 232 is disposed at a position slightly above the tip end opening 107c on a front side of the tip end opening 107c of the nozzle 107. The pressing roller 232 is rotatably attached to the main body frame 230 in a vertical plane. The function of the pressing roller 232 will be described later.

A motor 233 and a roller 234 driven by the motor 233 are attached to substantially a center of the main body frame 230. The roller 234 is rotatably attached to the opening/closing frame 235 in the vertical plane, and sandwiches the threadlike adhesive 2 with a roller 236 being rotated with the rotation of the roller 234 to feed out the threadlike adhesive 2 from the winding body 240. That is, the rollers 234 and 236 function as a feed out assist mechanism. The motor 233 is provided with a speed volume (not shown) for adjusting a rotation speed of the motor 233, that is, for manually adjusting a feed out speed of the threadlike adhesive 2.

The gripping portion 231 having a substantially rectangular plate shape is provided slightly below the center of the main body frame 230 so as to protrude rearward. The gripping portion 231 is gripped by an operator. The gripping portion 231 is provided with a switch 231A for switching on/off of the motor 233 to start/stop feed out of the threadlike adhesive 2. As an example, the switch 231A is provided at a position where the operator can easily operate the switch 231A with an index finger in a state where the operator grips the gripping portion 231, turns on the motor 233 while the switch 231A is pressed, and turns off the motor 233 in the case where the switch 231A is released from the pressing, that is, in the case where the switch 231A is not pressed.

The opening/closing frame 235 includes a roller holding unit 237 that rotatably holds the roller 236 in the vertical plane, and a winding body holding unit 238 that rotatably holds the winding body 240 in the vertical plane. The opening/closing frame 235 is pivotally supported by the main body frame 230 at a rear of a lower end side, and can be open and closed with respect to the main body frame 230.

In an open state shown in FIG. 14, the operator sets the winding body 240 in the winding body holding unit 238, and inserts the threadlike adhesive 2 into the inside of the nozzle 107 via a rotation surface of the roller 236. Then, the operator rotates the opening/closing frame 235, on which the winding body 240 is set, rearward to close the opening/closing frame 235, and engages an upper end thereof with the main body frame 230 to bring the opening/closing frame 235 into a closed state shown in FIG. 13.

As shown in FIG. 13, the operator grasps the gripping portion 231 to bring the tip end (tip end opening 107c) of the nozzle 107 close to an adherend. At this time, in the case where the extra length of the threadlike adhesive 2 is short, the operator lowers the nozzle 107 in an oblique direction as described above, so that the start point can be reliably created without the threadlike adhesive 2 entering the nozzle 107.

When the operator operates the switch 231A, the motor 233 is rotated, and the rollers 234 and 236 feed out the threadlike adhesive 2 from the winding body 240 by the rotation of the motor 233. When the operator moves the nozzle 107 on the adherend in any direction, the threadlike adhesive 2 fed out from the winding body 240 is stuck to the adherend in any path.

In the threadlike adhesive sticking apparatus 200A according to the second embodiment, the nozzle 107 can also be lowered at the nozzle lowering angle θ1 by using the moving mechanism for moving the nozzle 107 as in the first embodiment, instead of the operator lowering the nozzle 107 in the oblique direction.

Here, features of the threadlike adhesive sticking apparatus and the method of sticking a threadlike adhesive according to the embodiments of the present invention described above will be briefly summarized and listed in the following <1> to <12>.

<1> A threadlike adhesive sticking apparatus for sticking a threadlike adhesive to an object by pressing, using a nozzle, a part of the threadlike adhesive protruding from a tip end portion of the nozzle to an outside against a surface of the object, the apparatus including:
a moving mechanism configured to move the nozzle, in which
the moving mechanism moves the nozzle such that an angle θ1 (rad) formed by the surface and a moving direction of the nozzle to a sticking start point on the surface is π/36≤θ1≤4π/9.

<2> The threadlike adhesive sticking apparatus according to the above <1>, in which
a length L (mm) of an extra length portion, which is a length of the threadlike adhesive protruding from the tip end portion to the outside at the sticking start point, and an outer diameter R (mm) of the threadlike adhesive are represented by the following relational expression.

$$5. \leq L / R$$

<3> The threadlike adhesive sticking apparatus according to the above <1> or <2>, in which
a moving speed a (mm/sec) of the nozzle is in the following range.

$$1. \leq a \leq 40.0$$

<4> The threadlike adhesive sticking apparatus according to any one of the above <1> to <3>, in which
when a sticking direction of the threadlike adhesive from the sticking start point on the surface is defined as 0 (rad), a moving angle θ2 (rad) obtained by projecting the moving direction of the nozzle onto the surface is 11π/18≤θ2≤25π/18.

<5> The threadlike adhesive sticking apparatus according to any one of the above <1> to <4>, in which
the moving mechanism moves the nozzle from a moving start point to a moving direction switching point, and then moves the nozzle such that the angle θ1 (rad) formed by the surface and a moving direction of the nozzle from the moving direction switching point to the sticking start point on the surface is π/36≤θ1≤4π/9, and
when a sticking direction from the sticking start point on the surface is defined as 0 (rad), a moving angle θ3 (rad) obtained by projecting the moving direction of the nozzle from the moving direction switching point for the nozzle to the sticking start point onto the surface is 71.

<6> The threadlike adhesive sticking apparatus according to the above <5>, in which
a distance between the moving direction switching point and the surface is smaller than a length of an extra length portion which is a length of the threadlike adhesive protruding from the tip end portion to the outside at the sticking start point.

<7> A method of sticking a threadlike adhesive for sticking a threadlike adhesive to an object by pressing, using a nozzle, a part of the threadlike adhesive protruding from a tip end portion of the nozzle to an outside against a surface of the object, the method including:
moving the nozzle such that an angle θ1 (rad) formed by the surface and a moving direction of the nozzle to a sticking start point on the surface is π/36≤θ1≤4π/9.

<8> The method of sticking a threadlike adhesive according to the above <7>, in which
a length L (mm) of an extra length portion, which is a length of the threadlike adhesive protruding from the tip end portion to the outside at the sticking start point, and an outer diameter R (mm) of the threadlike adhesive are represented by the following relational expression.

$$5. \leq L / R$$

<9> The method of sticking a threadlike adhesive according to the above <7> or <8>, in which
a moving speed a (mm/sec) of the nozzle is in the following range.

$$1. \leq a \leq 40.0$$

<10> The method of sticking a threadlike adhesive according to any one of the above <7> to <9>, in which
when a sticking direction of the threadlike adhesive from the sticking start point on the surface is defined as 0 (rad), a moving angle θ2 (rad) obtained by projecting the moving direction of the nozzle onto the surface is 11π/18≤θ2≤25π/18.

<11> The method of sticking a threadlike adhesive according to any one of the above <7> to <10>, in which
the nozzle is moved from a moving start point to a moving direction switching point, and is then moved such that the angle θ1 (rad) formed by the surface and a moving direction of the nozzle from the moving direction switching point to the sticking start point on the surface is π/36≤θ1≤4π/9, and
when a sticking direction from the sticking start point on the surface is defined as 0 (rad), a moving angle θ3 (rad) obtained by projecting the moving direction of the nozzle from the moving direction switching point for the nozzle to the sticking start point onto the surface is 21.

<12> The method of sticking a threadlike adhesive according to the above <11>, in which
a distance between the moving direction switching point and the surface is smaller than a length of an extra length portion which is a length of the threadlike adhesive protruding from the tip end portion to the outside at the sticking start point.

### Examples and Comparative Examples

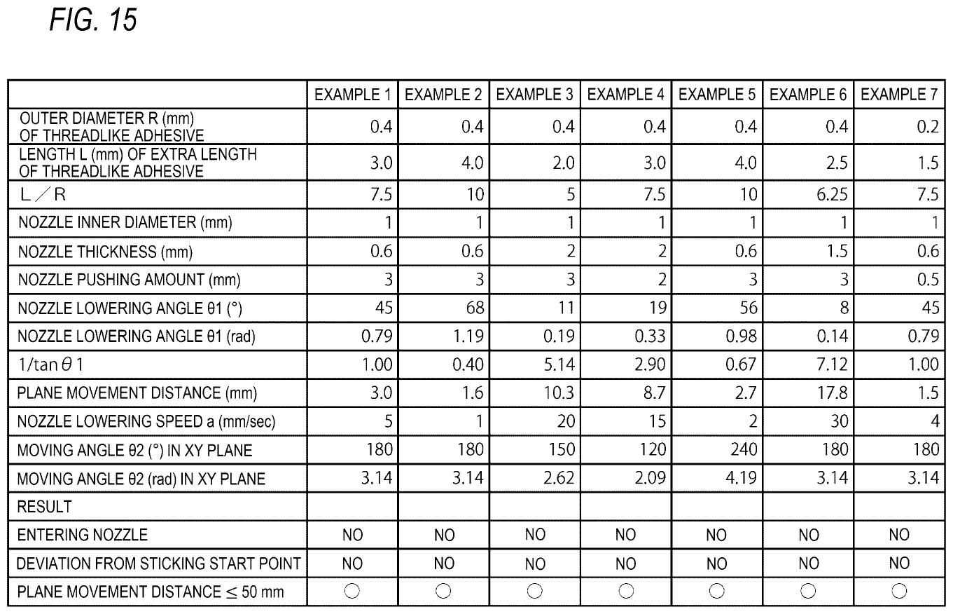

FIG. 15 is a table showing experimental results for Examples 1 to 7. In these Examples, as shown in FIGS. 5 to 7, the nozzle does not stop in the middle but moves in one stage from the moving start point to the sticking start point. In each example, the nozzle lowering angle θ1, the moving speed a, the moving angle θ2, and the L/R, which is the ratio of the length L of the extra length portion to the outer diameter R of the threadlike adhesive, all satisfy the ranges or values of the relational expressions described above. In each Example, no threadlike adhesive is observed to enter the nozzle or to deviate from the sticking start point.

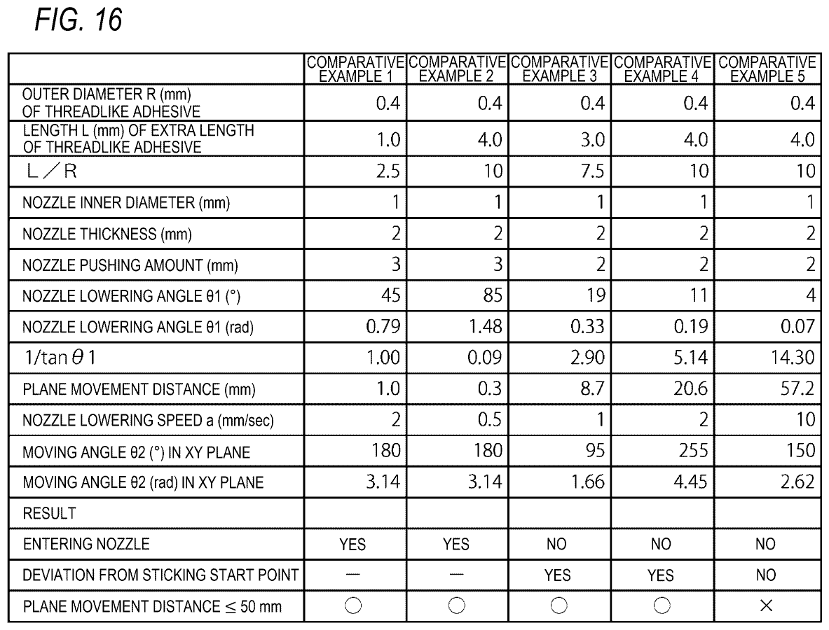

FIG. 16 is a table showing experimental results for Comparative Examples 1 to 5. In these Comparative Examples, as shown in FIGS. 5 to 7, the nozzle does not stop in the middle but moves in one stage from the moving start point to the sticking start point. In each Comparative Example, at least one of the nozzle lowering angle θ1, the moving speed a, the moving angle θ2, and the L/R does not satisfy the ranges or values of the relational expressions described above.

Specifically, the L/R in Comparative Example 1, the nozzle lowering angle 1 in Comparative Example 2, the moving angle θ2 in Comparative Example 3, the moving angle θ2 in Comparative Example 4, and the nozzle lowering angle θ1 in Comparative Example 5 do not satisfy the ranges or values of the relational expressions described above. In Comparative Examples 1 to 4, the threadlike adhesive is observed to enter the nozzle or to deviate from the sticking start point. In Comparative Example 5, these are not observed, but since the nozzle lowering angle θ1 is small, a plane movement distance in the XY plane is more than 50 mm, and the movement distance is increased.

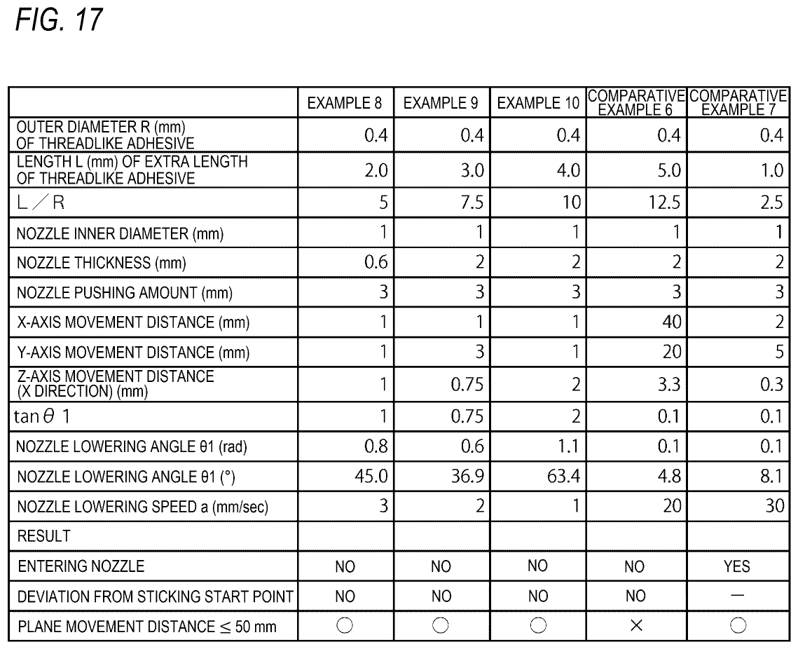

FIG. 17 is a table showing experimental results for Examples 8 to 10 and Comparative Examples 6 and 7. In these Examples and Comparative Examples, as shown in FIG. 12, the nozzle stops at the midpoint PM and moves from the moving start point to the sticking start point in two stages. In Examples 8 to 10, all of the nozzle lowering angle θ1, the moving speed a, the moving angle θ2, and the L/R satisfy the ranges or values of the relational expressions described above. In each Example, no threadlike adhesive is observed to enter the nozzle or to deviate from the sticking start point.

On the other hand, the nozzle lowering angle θ1 in Comparative Example 6 and the L/R in Comparative Example 7 do not satisfy the ranges or values of the relational expressions described above. In Comparative Example 7, the threadlike adhesive is observed to enter the nozzle. In Comparative Example 6, no threadlike adhesive is observed to enter the nozzle or to deviate from the sticking start point, but since the nozzle lowering angle θ1 is small, a plane movement distance in the XY plane is more than 50 mm, and the movement distance is increased.

Note that, the present invention is not limited to the embodiments described above, and modifications, improvements, and the like can be made as appropriate. Materials, shapes, sizes, numerical values, forms, numbers, arrangement locations, and the like of components in the embodiments described above are set as desired and are not limited as long as the present invention can be achieved. In addition, the present invention is not limited to the embodiments described above, and can be made in various modifications within the scope of the claims, and embodiments obtained by appropriately combining technical methods disclosed in different embodiments are also included in the technical scope of the present invention.

### INDUSTRIAL APPLICABILITY

According to the threadlike adhesive sticking apparatus and the method of sticking a threadlike adhesive of the present invention, the sticking accuracy at the sticking start point of the threadlike adhesive can be improved. Therefore, the present invention can be applied to bonding work in various fields.

### REFERENCE SIGNS LIST

2 threadlike adhesive
107 nozzle
220 chuck unit
221 roller
222 roller
200 threadlike adhesive sticking apparatus

1. A threadlike adhesive sticking apparatus for sticking a threadlike adhesive to an object by pressing, using a nozzle, a part of the threadlike adhesive protruding from a tip end portion of the nozzle to an outside against a surface of the object, the apparatus comprising:
a moving mechanism configured to move the nozzle, wherein
the moving mechanism moves the nozzle such that an angle θ1 (rad) formed by the surface and a moving direction of the nozzle to a sticking start point on the surface is
$$π / 36 \leq θ 1 \leq 4 π / 9.$$

2. The threadlike adhesive sticking apparatus according to claim 1, wherein
a length L (mm) of an extra length portion, which is a length of the threadlike adhesive protruding from the tip end portion to the outside at the sticking start point, and an outer diameter R (mm) of the threadlike adhesive are represented by the following relational expression:
$$5. \leq L / R .$$

3. The threadlike adhesive sticking apparatus according to claim 1, wherein
a moving speed a (mm/sec) of the nozzle is in the following range:
$$1. \leq a \leq 40. .$$

4. The threadlike adhesive sticking apparatus according to claim 1, wherein
when a sticking direction of the threadlike adhesive from the sticking start point on the surface is defined as 0 (rad), a moving angle θ2 (rad) obtained by projecting the moving direction of the nozzle onto the surface is
$$11 π / 18 \leq θ 2 \leq 25 π / 18.$$

5. The threadlike adhesive sticking apparatus according to claim 1, wherein
the moving mechanism moves the nozzle from a moving start point to a moving direction switching point, and then moves the nozzle such that the angle θ1 (rad) formed by the surface and a moving direction of the nozzle from the moving direction switching point to the sticking start point on the surface is
$$π / 36 \leq θ 1 \leq 4 π / 9 ,$$
and
when a sticking direction from the sticking start point on the surface is defined as 0 (rad), a moving angle θ3 (rad) obtained by projecting the moving direction of the nozzle from the moving direction switching point for the nozzle to the sticking start point onto the surface is π.

6. The threadlike adhesive sticking apparatus according to claim 5, wherein
a distance between the moving direction switching point and the surface is smaller than a length of an extra length portion which is a length of the threadlike adhesive protruding from the tip end portion to the outside at the sticking start point.

7. A method of sticking a threadlike adhesive for sticking a threadlike adhesive to an object by pressing, using a nozzle, a part of the threadlike adhesive protruding from a tip end portion of the nozzle to an outside against a surface of the object, the method comprising:
moving the nozzle such that an angle θ1 (rad) formed by the surface and a moving direction of the nozzle to a sticking start point on the surface is
$$π / 36 \leq θ 1 \leq 4 π / 9.$$

8. The method of sticking a threadlike adhesive according to claim 7, wherein
a length L (mm) of an extra length portion, which is a length of the threadlike adhesive protruding from the tip end portion to the outside at the sticking start point, and an outer diameter R (mm) of the threadlike adhesive are represented by the following relational expression:
$$5. \leq L / R .$$

9. The method of sticking a threadlike adhesive according to claim 7, wherein
a moving speed a (mm/sec) of the nozzle is in the following range:
$$1. \leq a \leq 40. .$$

10. The method of sticking a threadlike adhesive according to claim 7, wherein
when a sticking direction of the threadlike adhesive from the sticking start point on the surface is defined as 0 (rad), a moving angle θ2 (rad) obtained by projecting the moving direction of the nozzle onto the surface is
$$11 π / 18 \leq θ 2 \leq 25 π / 18.$$

11. The method of sticking a threadlike adhesive according to claim 7, wherein
the nozzle is moved from a moving start point to a moving direction switching point, and is then moved such that the angle θ1 (rad) formed by the surface and a moving direction of the nozzle from the moving direction switching point to the sticking start point on the surface is
$$π / 36 \leq θ 1 \leq 4 π / 9 ,$$
and
when a sticking direction from the sticking start point on the surface is defined as 0 (rad), a moving angle θ3 (rad) obtained by projecting the moving direction of the nozzle from the moving direction switching point for the nozzle to the sticking start point onto the surface is π.

12. The method of sticking a threadlike adhesive according to claim 11, wherein
a distance between the moving direction switching point and the surface is smaller than a length of an extra length portion which is a length of the threadlike adhesive protruding from the tip end portion to the outside at the sticking start point.
